(19) United States
(12) Patent Application Publication
(10) Pub. No.: US 2023/0379253 A1
(43) Pub. Date: Nov. 23, 2023

(54) DATA RELAY APPARATUS, DATA RELAY METHOD, AND NON-TRANSITORY COMPUTER-READABLE MEDIUM STORING DATA RELAY PROGRAM

(71) Applicant: NEC Corporation, Tokyo (JP)

(72) Inventors: Tamotsu MUKAIYACHI, Tokyo (JP); Shohei NISHIYAMA, Tokyo (JP)

(73) Assignee: NEC Corporation, Tokyo (JP)

(21) Appl. No.: 18/198,426

(22) Filed: May 17, 2023

(30) Foreign Application Priority Data
May 23, 2022 (JP) 2022-083587

(51) Int. Cl. H04L 47/11; H04L 49/90; H04L 47/12

(52) U.S. Cl. CPC H04L 47/11; H04L 49/90; H04L 47/12

(57) ABSTRACT

A data relay apparatus in related art has a problem that a detection timing of congestion is delayed. A data relay apparatus according to one example embodiment includes a communication processing unit configured to relay a packet to be transmitted and received between a client apparatus and a server apparatus and a congestion determination processing unit configured to make a determination about a congestion degree which indicates a congestion state occurring to communication between the own apparatus and the client apparatus based on a packet size of an acknowledgement packet which is issued by the client apparatus in response to an acknowledgement induction instruction, the acknowledgement induction instruction being transmitted from the server apparatus to the client apparatus, among the packets.

### INCORPORATION BY REFERENCE

This application is based upon and claims the benefit of priority from Japanese patent application No. 2022-83587, filed on May 23, 2022, the disclosure of which is incorporated herein in its entirety by reference.

### TECHNICAL FIELD

The present disclosure relates to a data relay apparatus, a data relay method, and a non-transitory computer-readable medium storing a data relay program and relates particularly to a data relay apparatus, a data relay method, and a data relay program which relay data communication between a client apparatus and an origin server and a non-transitory computer-readable medium storing the data relay program.

### BACKGROUND ART

In recent years, accompanying spread of high-functioning client apparatuses such as smartphones and tablets, traffic of mobile networks has been increasing. For example, as for a mobile network, there is a connection form in which a data relay apparatus such as a router apparatus is arranged between a base station and a client apparatus and a plurality of client apparatuses belong to the data relay apparatus. In a case where communication via such a data relay apparatus is performed, a throughput might be lowered due to congestion occurring in a communication section between the data relay apparatus and the client apparatus. Accordingly, International Patent Publication No. WO 2020/12973 discloses a throughput improvement technique against congestion. A communication control apparatus disclosed in International Patent Publication No. WO 2020/12973 includes a first communication processing unit which receives, from a transmission apparatus, a packet to be transmitted from the transmission apparatus to a reception apparatus, the packet being not capable of being generated or altered at a relay point between the transmission apparatus and the reception apparatus, and a second communication processing unit which transmits the packet to the reception apparatus. The second communication processing unit receives, from the reception apparatus, an acknowledgement packet for the packet, the acknowledgement packet being not capable of being generated or altered at a relay point between the reception apparatus and the transmission apparatus. The first communication processing unit transmits the acknowledgement packet to the transmission apparatus. The communication control apparatus further includes a control unit which performs control of the packet or the acknowledgement packet such that the transmission apparatus changes a transmission speed.

### SUMMARY

However, in a communication control apparatus disclosed in International Patent Publication No. WO 2020/12973, an acknowledgement packet is transmitted to a transmission apparatus, and the transmission apparatus is demanded to change a communication speed. Thus, when the communication processing apparatus disclosed in International Patent Publication No. WO 2020/12973 is used as a data relay apparatus, there is a problem that a delay occurs to a detection timing of congestion occurring in a communication section between the data relay apparatus and a client apparatus.

The present disclosure has been made to solve the above-described problem, and an example object thereof is to provide a data relay apparatus which early detects congestion occurring in a communication section between a data relay apparatus and a client apparatus.

One example embodiment provides a data relay apparatus including: a communication processing unit configured to relay at least one packet to be transmitted and received between a client apparatus and a server apparatus; and a congestion determination processing unit configured to make a determination about a congestion degree which indicates a congestion state occurring to communication between the own apparatus and the client apparatus based on a packet size of an acknowledgement packet which is issued by the client apparatus in response to an acknowledgement induction instruction, the acknowledgement induction instruction being transmitted from the server apparatus to the client apparatus, among the at least one packet.

One example embodiment provides a data relay method in a relay apparatus configured to relay packet communication performed between a client apparatus and a server apparatus, the data relay method causing a processor to perform: a communication process of relaying at least one packet to be transmitted and received between the client apparatus and the server apparatus;

and a congestion determination process of making a determination about a congestion degree which indicates a congestion state occurring to communication between the own apparatus and the client apparatus based on a packet size of an acknowledgement packet which is issued by the client apparatus in response to an acknowledgement induction instruction, the acknowledgement induction instruction being transmitted from the server apparatus to the client apparatus, among the at least one packet.

One example embodiment provides a non-transitory computer-readable medium storing a data relay program, the data relay program causing a computer to execute: a communication process of relaying at least one packet to be transmitted and received between a client apparatus and a server apparatus; and a congestion determination process of making a determination about a congestion degree which indicates a congestion state occurring to communication between the own apparatus and the client apparatus based on a packet size of an acknowledgement packet which is issued by the client apparatus in response to an acknowledgement induction instruction, the acknowledgement induction instruction being transmitted from the server apparatus to the client apparatus, among the at least one packet.

The data relay apparatus, the data relay method, and the data relay program according to the example embodiments can detect congestion occurring in a communication section between the data relay apparatus and the client apparatus before the acknowledgement packet reaches the server apparatus.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a schematic diagram of a communication system according to a first example embodiment;

FIG. 2 is a diagram for explaining an outline of an action of a data relay apparatus according to the first example embodiment;

FIG. 3 is a diagram for explaining a data structure of an ACK packet;

FIG. 4 is a diagram for explaining a relationship between a drop rate of data and a packet size of the ACK packet;

FIG. 5 is a detailed block diagram of the data relay apparatus according to the first example embodiment;

FIG. 6 is a sequence diagram for explaining an action of the communication system according to the first example embodiment;

FIG. 7 is a sequence diagram for explaining the action of the data relay apparatus according to the first example embodiment; and

FIG. 8 is a block diagram for explaining an example of a hardware configuration of the data relay apparatus according to the first example embodiment.

### EXAMPLE EMBODIMENTS

For clarification of descriptions, omission and simplification are appropriately made in the following descriptions and drawings. Elements illustrated in the drawings as function blocks which perform various processes can be configured with a central processing unit (CPU), a memory, and other circuits as hardware and are realized by programs and so forth loaded in memories as software. Consequently, a fact that those function blocks can be realized in various forms by only hardware, only software, or combinations of those is understood by a person having ordinary skill in the art, and those function blocks are not limited to any form. In the drawings, the same reference characters are given to the same elements, and repetitions of descriptions will be skipped as needed.

The above-described program includes an instruction group (or a software code) to cause a computer to perform one or more functions described in example embodiments in a case where the above-described program is read by the computer. The program may be stored in non-transitory computer-readable media or tangible storage media. As not limitations but examples, the computer-readable media or the tangible storage media include a random access memory (RAM), a read-only memory (ROM), a flash memory, a solid state drive (SSD), or other memory techniques, a CD-ROM, a digital versatile disc (DVD), a Blu-ray disc™, or other optical disc storages, and a magnetic tape cassette, a magnetic tape, a magnetic disk storage, or other magnetic storage devices. The program may be transmitted on transitory computer-readable media or communication media. As not limitations but examples, the transitory computer-readable media or the communication media include electric, optical, and acoustic propagation signals or propagation signals of other types.

### First Example Embodiment

An example embodiment of the present disclosure will hereinafter be described with reference to the drawings. FIG. 1 illustrates a block diagram of a communication system 1 according to a first example embodiment. As illustrated in FIG. 1, the communication system 1 according to the first example embodiment has a client apparatus 10, a server apparatus (for example, an origin server 20), and a data relay apparatus 30.

In the communication system 1, data communication using a packet is performed between the client apparatus 10 and the origin server 20, and the data communication is relayed by the data relay apparatus 30. In the communication system 1 according to the first example embodiment, as a communication protocol for a transport layer which is used for the data communication, the Quick UDP Internet Connections (QUIC) are used which are proposed based on the User Datagram Protocol (UDP). Details of this QUIC will be described later.

In the example illustrated in FIG. 1, an example is illustrated where one-to-one communication is performed while a communication section between the client apparatus 10 and the data relay apparatus 30 is set as a wireless section, but a configuration is possible in which one data relay apparatus 30 is provided for a plurality of client apparatuses 10. The wireless section may be set as a wired communication section or as a communication section in which wired communication and wireless communication are mixed. In the example illustrated in FIG. 1, the communication section between the data relay apparatus and the origin server 20 is set as a public communication network section, but it does not matter whether a connection form of the public communication network section is a wired form or a wireless form.

The data relay apparatus 30 relays communication between the client apparatus 10 and the data relay apparatus 30. The data relay apparatus 30 makes a determination about a congestion degree which indicates a congestion state occurring to the communication between the origin server 20 and the client apparatus 10 based on a packet size of an acknowledgement packet (ACK (ACKnowledgement) packet) which is issued by the client apparatus 10 in response to an acknowledgement induction instruction, the acknowledgement induction instruction being transmitted from the origin server 20 to the client apparatus 10, among packets which are transmitted and received between the client apparatus 10 and the origin server 20. The congestion degree, which is defined by set values at two levels of high and low, indicates whether or not congestion is present. The congestion degree, which is defined by set values at multiple levels, serves as an index indicating an extent of congestion. The data relay apparatus 30 changes a communication speed between the client apparatus and the data relay apparatus 30 based on the detected congestion degree.

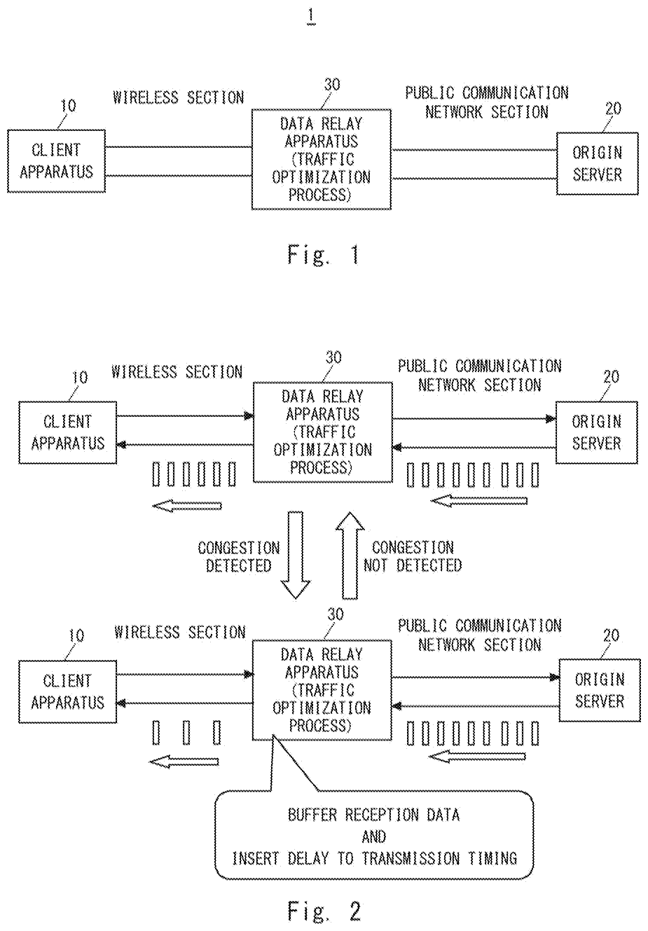

Accordingly, a description will be made about an outline of an action of the data relay apparatus 30. FIG. 2 illustrates a diagram for explaining the outline of the action of the data relay apparatus 30 according to the first example embodiment. The example illustrated in FIG. 2 is an example where the congestion degree is defined by set values at two levels.

As illustrated in FIG. 2, in a case where congestion is detected based on the packet size of the ACK packet, the data relay apparatus 30 slows the communication speed in the wireless section compared to the communication speed in the public communication network section. In this case, the data relay apparatus 30 accumulates, in an internal reception data buffer, reception data which cannot be transmitted due to a speed difference between the public communication network section and the wireless section.

In a case where it is determined that congestion is not occurring in the wireless section based on the packet size of the ACK packet, the data relay apparatus 30 returns the communication speed in the wireless section to an original speed. In a case where it is determined that congestion is not occurring, the communication speed in the wireless section can be increased compared to the communication speed in the public communication network section.

As described above, the data relay apparatus 30 makes a determination about congestion based on the packet size of the ACK packet. Accordingly, the data relay apparatus 30 is enabled to make a determination about congestion without interpreting a content of the ACK packet. This is particularly advantageous in a case where the client apparatus 10 and the origin server 20 perform communication by using an encrypted packet such as that of the QUIC. Accordingly, a QUIC protocol will be described in detail. The QUIC protocol is a communication protocol for a transport layer, which is proposed based on a UDP protocol. The UDP is different from the Transmission Control Protocol (TCP) related to connection and has a characteristic of continuing to transmit data without controlling congestion; in other words, the QUIC based on the UDP has no mechanism for controlling congestion. This QUIC protocol is employed for “HTTP/3” as one of Hypertext Transfer Protocols (HTTP), and expanded use in the future is expected.

In a trend of tightening of regulations in recent years, in discussions on regulations about neutrality of networks, discussions have been made on the fact that user authentication is set as a mandatory requirement for reference to a content of communication in an intermediate path of communication by a third party. Based on such a situation, the data relay apparatus 30 is requested to have a procedure for determining whether or not congestion is present without referring to the content of the packet. Because in the QUIC protocol, the packet is encrypted and the content cannot be checked, it is meaningful for the data relay apparatus 30, which relays communication based on the QUIC protocol, to determine whether or not congestion is present without checking the content.

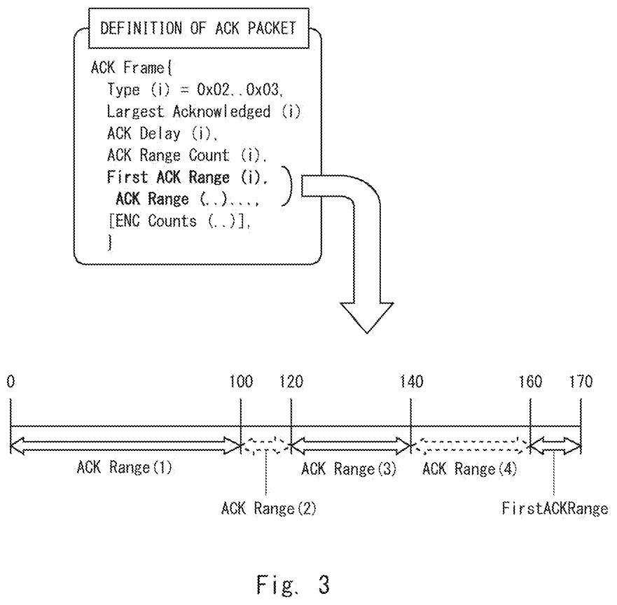

The origin server 20 determines whether or not congestion is present based on the packet size of the ACK packet. Accordingly, the content of the ACK packet will be described. Accordingly, FIG. 3 illustrates a diagram for explaining a data structure of the ACK packet.

As illustrated in FIG. 3, the ACK packet used in the QUIC protocol includes a number of a packet reaching a reception side and a number of an undelivered packet. The example illustrated in FIG. 3 is an example where 0th to 100th and 120th to 140th packets reach the reception side but 100th to 120th and 140th to 160th packets are undelivered. In the ACK packet, when switches between the packets reaching the reception side and the packets undelivered to the reception side increase, the number of ACK ranges tends to increase, and the packet size tends to become large.

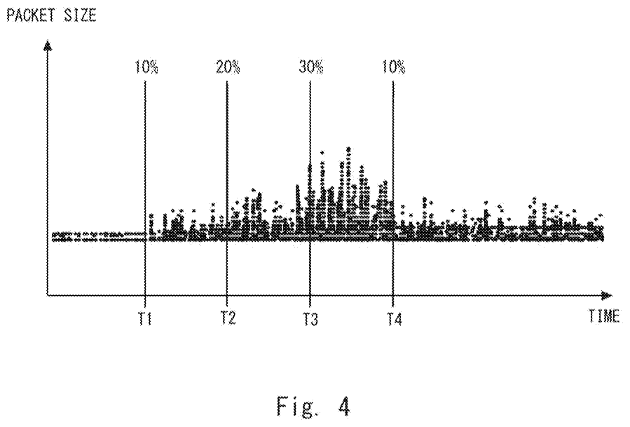

For example, when congestion occurs in the wireless section, the packets which are undelivered to the reception side tend to increase. The undelivered packet occurs at a random timing. Based on such a situation, the packet size of the ACK packet tends to increase as the degree of congestion becomes higher. Accordingly, FIG. 4 illustrates a diagram for explaining a relationship between a drop rate of data and the packet size of the ACK packet. FIG. 4 illustrates one example where a relationship between the packet size of the ACK packet and the drop rate indicating a ratio of undelivered packets is inspected. In FIG. 4, the horizontal axis is set as time, and the vertical axis is set as the packet size of the ACK packet.

The example illustrated in FIG. 4 indicates, at a timing T1 or before that, results of inspection of the packet sizes of the ACK packets in a case where communication was performed at a drop rate of less than 10%. Communication for which the drop rate was set to 10% was performed in a period between timings T1 and T2 and a period from a timing T4, communication for which the drop rate was set to 20% was performed in a period between timings T2 and T3, and communication for which the drop rate was set to 30% was performed in a period between timings T3 and T4. As illustrated in FIG. 3, the packet size of the ACK packet tends to become larger as the drop rate becomes higher.

The data relay apparatus 30 according to the first example embodiment makes a determination about the congestion degree of the wireless section based on the packet size obtained as a result of application of a smoothing procedure, which corresponds to specifications of the system, such as a moving average of the packet sizes of the ACK packets, an envelope indicating transition of the packet size, and a determination about dispersion of the packet sizes.

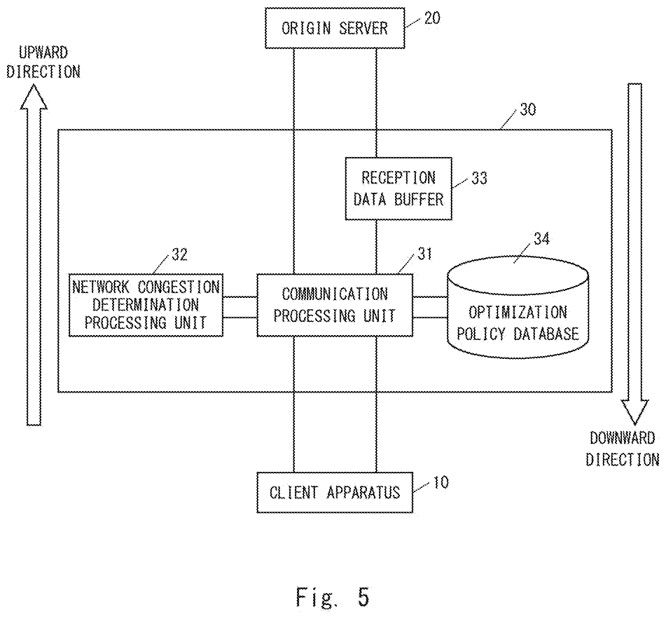

Here, the data relay apparatus 30 will be described more in detail. FIG. 5 illustrates a detailed block diagram of the data relay apparatus 30 according to the first example embodiment. FIG. 5 illustrates the client apparatus 10 and the origin server 20 in order to indicate a relationship among the data relay apparatus 30, the client apparatus 10, and the origin server 20. FIG. 5 illustrates arrows while setting a direction of flow of the packet from the client apparatus 10 toward the origin server 20 as an upward direction and setting a direction of flow of the packet from the origin server 20 toward the client apparatus 10 as a downward direction.

As illustrated in FIG. 5, the data relay apparatus 30 has a communication processing unit 31, a network congestion determination processing unit 32, a reception data buffer 33, and a database (for example, an optimization policy database 34).

The communication processing unit 31 relays the packet to be transmitted and received between the client apparatus 10 and the origin server 20. The network congestion determination processing unit 32 makes a determination about the congestion degree which indicates the congestion state occurring to the communication between the origin server 20 and the client apparatus 10 based on the packet size of the acknowledgement packet (for example, the ACK packet) which is issued by the client apparatus in response to the acknowledgement induction instruction, the acknowledgement induction instruction being transmitted from the origin server 20 to the client apparatus 10, among the packets. The network congestion determination processing unit 32 determines that the congestion degree is higher as the packet size of the ACK packet is larger.

The reception data buffer 33 accumulates the packets transmitted from the origin server 20 toward the client apparatus 10 and passes the accumulated packets to the communication processing unit 31. The optimization policy database 34 stores an optimization policy which corresponds to the congestion degree and indicates a relationship with a communication speed from the data relay apparatus 30 to the client apparatus 10. The communication processing unit 31 refers to the optimization policy database 34 based on the congestion degree notified from the network congestion determination processing unit 32, applies the communication speed designated by the optimization policy corresponding to the congestion degree, and thereby transmits the packet from the data relay apparatus 30 to the client apparatus 10. More specifically, the communication processing unit 31 adjusts a packet acquisition speed from the reception data buffer 33 in accordance with a speed corresponding to the communication speed designated by the optimization policy and thereby adjusts the communication speed in a case of transmitting the packet to the client apparatus 10.

The communication processing unit 31 applies the optimization policy for which a slower communication speed is designated as the congestion degree indicated by the network congestion determination processing unit 32 is higher and applies the optimization policy for which a faster communication speed is designated as the congestion degree is lower. From another point of view, the communication processing unit 31 increases a transmission delay of the packet when the congestion degree is high and eliminates the transmission delay of the packet when the congestion degree is low.

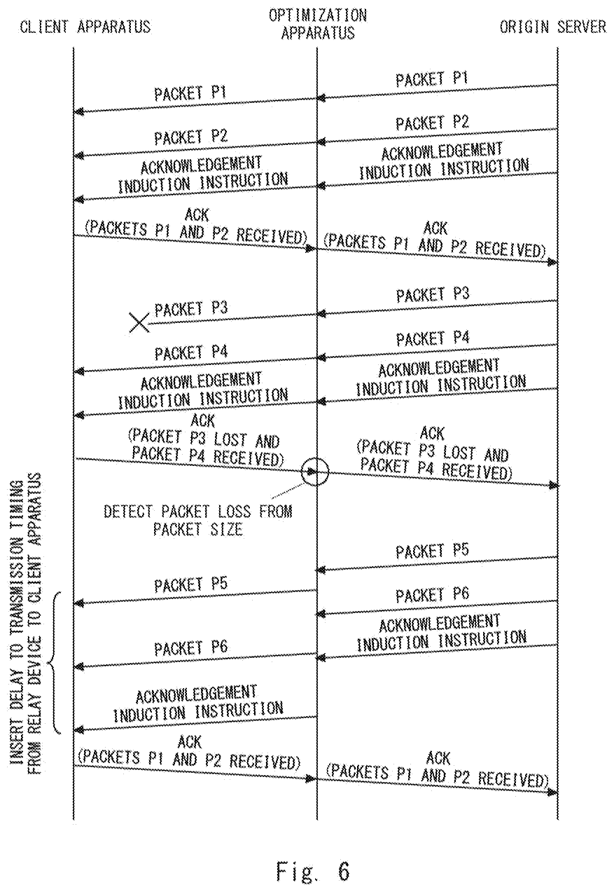

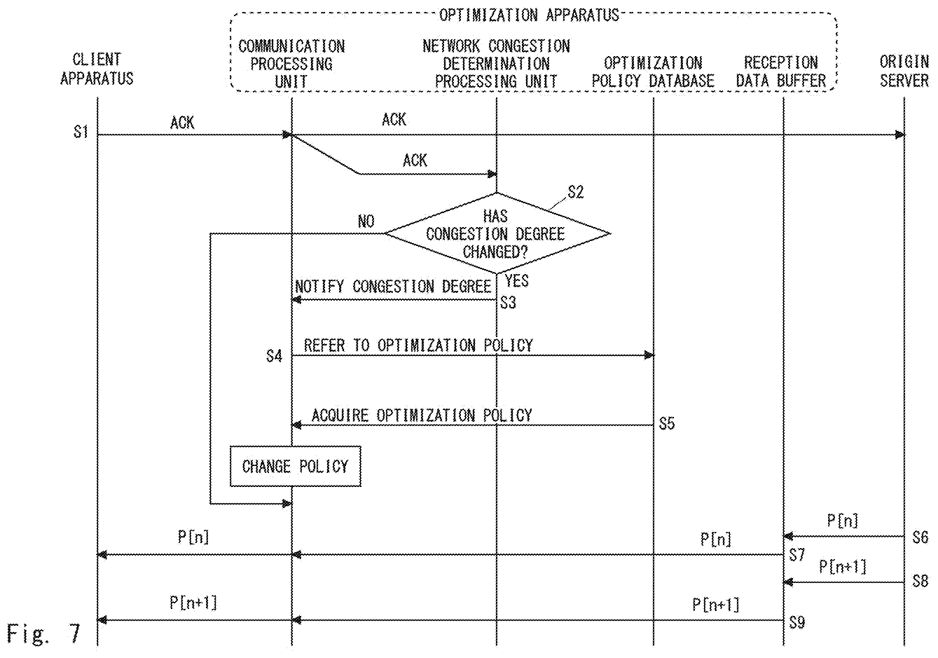

Next, a description will be made about an action of the communication system 1 according to the first example embodiment, which uses the data relay apparatus 30. Accordingly, FIG. 6 illustrates a sequence diagram for explaining the action of the communication system according to the first example embodiment. In FIG. 6, in order to simplify the explanation, two packets are transmitted from the origin server 20 to the client apparatus 10 in a reply interval of the ACK packet, but actually, two or more, a plurality of packets are transmitted.

As illustrated in FIG. 6, in the communication system 1 according to the first example embodiment, for example, in a case where a rate at which the packets reach is high as packets P1 and P2 (the drop rate is low), the data relay apparatus 30 transfers the packets at the speed equivalent to the speed at which the packets received from the origin server 20 are received. Because no undelivered packet is present, the client apparatus 10 sends a reply with the ACK packet, which indicates a success of reception of the packets P1 and P2, to the origin server 20 in response to the acknowledgement induction instruction transmitted from the origin server 20.

In FIG. 6, a packet P3 transmitted from the origin server 20 after the packets P1 and P2 is undelivered. On the other hand, a packet P4 transmitted from the origin server 20 after the packet P3 reaches the client apparatus 10. Accordingly, the client apparatus 10 sends a reply with the ACK packet, which indicates that the packet P3 is undelivered and the packet P4 is successfully received, to the origin server 20 in response to the acknowledgement induction instruction transmitted from the origin server 20. In this case, the data relay apparatus 30 recognizes that packet loss has occurred based on an increase in the packet size of the ACK packet and determines that the congestion degree is high. Accordingly, the communication processing unit 31 changes the optimization policy to be applied and thereafter lowers the communication speed on the client apparatus 10 side.

In FIG. 6, packets P5 and P6 transmitted from the origin server 20 after the packet P4 reach the client apparatus 10. However, because the communication processing unit 31 lowers the communication speed on the client apparatus 10 side in accordance with the packet size of the ACK packet corresponding to the packets P3 and P4, the packets P5 and P6 are sent from the data relay apparatus 30 to the client apparatus 10 at a transmission interval longer than a transmission interval from the origin server 20. In other words, the data relay apparatus 30 inserts a delay to a transmission timing from the data relay apparatus 30 to the client apparatus 10 and thereby suppresses the communication speed from the data relay apparatus 30 to the client apparatus 10 side.

In FIG. 6, a description is made about an example where the communication speed of the data relay apparatus 30 on the client apparatus 10 side is made slower, but the data relay apparatus 30 can make faster the communication speed on the client apparatus 10 side in accordance with a level of the congestion degree.

Next, the action of the data relay apparatus 30 will be described more in detail. Accordingly, FIG. 7 illustrates a sequence diagram for explaining the action of the data relay apparatus 30 according to the first example embodiment. The sequence diagram illustrated in FIG. 7 in detail illustrates the action of the data relay apparatus 30 in FIG. 6, which is performed until two packets are transmitted from the origin server 20 after the client apparatus 10 transmits the ACK packet.

As illustrated in FIG. 7, when the ACK packet is received from the client apparatus 10, the communication processing unit 31 of the data relay apparatus 30 transmits the received ACK packet to the origin server 20 and also to the network congestion determination processing unit 32 (step S1).

The network congestion determination processing unit 32 makes a determination about the congestion degree by referring to the packet size of the ACK packet and determines whether or not the congestion degree has changed from the immediately previous congestion degree (step S2). When the congestion degree has not changed in this step S2, communication is continued without changing the optimization policy applied to the communication processing unit 31. On the other hand, in a case where the congestion degree has changed in step S2, the congestion degree calculated in step S2 is notified from the network congestion determination processing unit 32 to the communication processing unit 31 (step S3).

The communication processing unit 31 thereafter refers to the optimization policy stored in the optimization policy database 34 (step S4) and acquires the optimization policy corresponding to the notified congestion degree (step S5). The communication processing unit 31 applies the optimization policy acquired in step S5 and thereby changes the policy which designates the transmission speed. It is assumed that the optimization policy is stored in the optimization policy database 34 based on results obtained by inspecting the communication speed, at which congestion can be eliminated, with respect to each congestion degree in inspection performed in advance.

At each time when the packet is received from the origin server 20, the data relay apparatus 30 accumulates the received packet in the reception data buffer 33 (steps S6 and S8). The communication processing unit 31 acquires the packet from the reception data buffer 33 in accordance with the policy updated in step S5 and transmits the packet to the client apparatus 10 (steps S7 and S9).

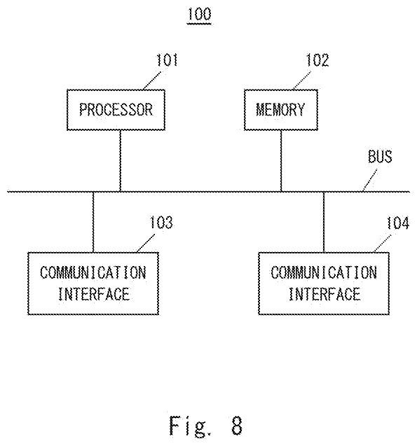

Here, a description will be made about a hardware configuration of the data relay apparatus 30. FIG. 8 illustrates a block diagram for explaining the hardware configuration of the data relay apparatus 30 according to the first example embodiment. The example illustrated in FIG. 8 is an example where a computer 100 is used as the data relay apparatus 30. The computer 100 illustrated in FIG. 8 has an arithmetic unit 101, a memory 102, and communication interfaces 103 and 104. The arithmetic unit 101, the memory 102, and the communication interfaces 103 and 104 are configured to be capable of mutual communication by a bus.

The arithmetic unit 101 is an arithmetic apparatus such as a central processing unit (CPU) which is capable of executing a program, for example, executes a data relay program as a program, and thereby realizes functions of the above-described data relay apparatus 30.

The memory 102 is configured with at least one of a volatile memory such as a dynamic random access memory (DRAM) and a non-volatile memory such as a flash memory. The memory 102 serves as the reception data buffer 33, for example.

The communication interface 103 is an interface circuit for performing communication with the origin server 20 in the data relay apparatus 30, for example, and the communication interface 104 is an interface circuit for performing communication with the client apparatus 10 in the data relay apparatus 30, for example. The communication interfaces 103 and 104 cooperate with the arithmetic unit 101 to transmit and receive the packet.

As described above, the data relay apparatus 30 according to the first example embodiment acquires the ACK packet issued by the client apparatus 10 earlier than the origin server 20 and determines whether or not congestion is present based on the packet size of the ACK packet. Accordingly, the data relay apparatus 30 can detect the congestion occurring in the wireless section between the client apparatus 10 and the data relay apparatus 30 earlier than the origin server 20.

Because the data relay apparatus 30 determines whether or not congestion is present based on the packet size of the ACK packet, the content of the ACK packet does not have to be inspected. Accordingly, the data relay apparatus 30 can correctly determine whether or not congestion is present in a communication scheme such as the QUIC protocol in which an encrypted packet is transmitted and received.

Because the data relay apparatus 30 determines whether or not congestion is present based on the packet size of the ACK packet and the content of the ACK packet does not have to be inspected, a determination about whether or not congestion is present is not disturbed even when the regulations about neutrality of networks are tightened.

In a situation where it is determined that congestion is occurring, the data relay apparatus 30 suppresses the communication speed on the client apparatus 10 side, can thereby prevent packet loss, and can improve a throughput of communication as a result. In a case where congestion in the wireless section is eliminated, the data relay apparatus 30 again improves the communication speed on the client apparatus 10 side and can thereby improve the throughput of communication.

The program can be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g. magneto-optical disks), a compact disc read-only memory (CD-ROM), a compact disc recordable (CD-R), a compact disc rewritable (CD-R/W), and semiconductor memories (such as mask ROM, programmable ROM (PROM), erasable PROM

(EPROM), flash ROM, random access memory (RAM), etc.). The program may be provided to a computer using any type of transitory computer-readable media. Examples of transitory computer-readable media include electric signals, optical signals, and electromagnetic waves. Transitory computer-readable media can provide the program to a computer via a wired communication line (e.g. electric wires, and optical fibers) or a wireless communication line.

The present disclosure is not limited to the above embodiment but can appropriately be modified without departing from the scope of the gist thereof.

What is claimed is:

1. A data relay apparatus comprising:
a communication processing unit configured to relay at least one packet to be transmitted and received between a client apparatus and a server apparatus; and
a congestion determination processing unit configured to make a determination about a congestion degree which indicates a congestion state occurring to communication between the own apparatus and the client apparatus based on a packet size of an acknowledgement packet which is issued by the client apparatus in response to an acknowledgement induction instruction, the acknowledgement induction instruction being transmitted from the server apparatus to the client apparatus, among the at least one packet.

2. The data relay apparatus according to claim 1, wherein the congestion determination processing unit determines that the congestion degree is higher as the packet size of the acknowledgement packet is larger.

3. The data relay apparatus according to claim 1, further comprising:
a reception data buffer configured to accumulate at least one packet transmitted from the server apparatus toward the client apparatus and to pass the at least one packet, which is accumulated, to the communication processing unit; and
a database configured to store an optimization policy which corresponds to the congestion degree and indicates a relationship with a communication speed from the own apparatus to the client apparatus,
wherein the communication processing unit refers to the database based on the congestion degree notified from the congestion determination processing unit, applies a communication speed designated by the optimization policy corresponding to the congestion degree, and transmits the at least one packet from the own apparatus to the client apparatus.

4. The data relay apparatus according to claim 3, wherein the communication processing unit applies the optimization policy for which the slower communication speed is designated as the congestion degree is higher.

5. The data relay apparatus according to claim 4, wherein the communication processing unit applies the optimization policy for which the faster communication speed is designated as the congestion degree is lower.

6. The data relay apparatus according to claim 3, wherein the communication processing unit changes a data reading speed from the reception data buffer in accordance with the communication speed designated by the optimization policy to be applied.

7. The data relay apparatus according to claim 1, wherein a size of the acknowledgement packet is increased as a ratio of the at least one packet which is from the server apparatus and reaches the client apparatus becomes lower.

8. The data relay apparatus according to claim 1, wherein the acknowledgement packet is a packet which conforms to a QUIC protocol proposed as a communication protocol for a transport layer.

9. A data relay method in a relay apparatus configured to relay packet communication performed between a client apparatus and a server apparatus, the data relay method causing a processor to perform:
a communication process of relaying at least one packet to be transmitted and received between the client apparatus and the server apparatus; and
a congestion determination process of making a determination about a congestion degree which indicates a congestion state occurring to communication between the own apparatus and the client apparatus based on a packet size of an acknowledgement packet which is issued by the client apparatus in response to an acknowledgement induction instruction, the acknowledgement induction instruction being transmitted from the server apparatus to the client apparatus, among the at least one packet.

10. A non-transitory computer-readable medium storing a data relay program, the data relay program causing a computer to execute:
a communication process of relaying at least one packet to be transmitted and received between a client apparatus and a server apparatus; and
a congestion determination process of making a determination about a congestion degree which indicates a congestion state occurring to communication between the own apparatus and the client apparatus based on a packet size of an acknowledgement packet which is issued by the client apparatus in response to an acknowledgement induction instruction, the acknowledgement induction instruction being transmitted from the server apparatus to the client apparatus, among the at least one packet.
